(19) United States
(12) Patent Application Publication
(10) Pub. No.: US 2021/0381428 A1
(43) Pub. Date: Dec. 9, 2021

(54) COMPRESSED AIR ENERGY STORAGE POWER GENERATION DEVICE AND COMPRESSED AIR ENERGY STORAGE POWER GENERATION METHOD

(71) Applicant: KABUSHIKI KAISHA KOBE SEIKO SHO (KOBE STEEL, LTD.), Hyogo (JP)

(72) Inventors: Takashi SATO, Takasago-shi, Hyogo (JP); Ryo NAKAMICHI, Takasago-shi, Hyogo (JP)

(73) Assignee: KABUSHIKI KAISHA KOBE SEIKO SHO (KOBE STEEL, LTD.), Hyogo (JP)

(21) Appl. No.: 17/284,894

(22) PCT Filed: Nov. 11, 2019
(86) PCT No.: PCT/JP2019/044123

§ 371 Date: Apr. 13, 2021

(30) Foreign Application Priority Data
Nov. 28, 2018 (JP) 2018-222617

(51) Int. Cl. F02C 1/02; F02C 9/00

(52) U.S. Cl. CPC F02C 1/02; F05D 2220/76; F02C 9/00

(57) ABSTRACT

A compressed air energy storage power generation device includes a compression/expansion combined machine having a function to produce compressed air utilizing electric power and a function to generate electric power utilizing the compressed air, a pressure storage unit that is fluidly connected to the compression/expansion combined machine and stores the compressed air, inverters that adjust rotation speed of the compression/expansion combined machine, a flow rate adjustment valve that adjusts amount of the compressed air supplied from the pressure storage unit to the compression/expansion combined machine, and a control device that reduces, when receiving a command value that reduces amount of power generated by the compression/expansion combined machine, amount of power generated by the compression/expansion combined machine by making the inverters to reduce rotation speed of the compression/expansion combined machine and decreasing an opening degree of the flow rate adjustment valve.

### TECHNICAL FIELD

The present invention relates to a compressed air energy storage power generation device and a compressed air energy storage power generation method.

### BACKGROUND ART

Amount of power generated by utilizing renewable energy such as wind power or solar power fluctuates depending on weather. In order to smooth fluctuations in power generation amount, an energy storage device may be installed with a power plant such as a wind power plant or solar power plant that utilizes renewable energy. As an example of such an energy storage device, a compressed air energy storage (CAES) power generation device is known. The CAES power generation device produces compressed air by utilizing electric power, stores the compressed air, and generates electric power with a turbine power generator, or the like by utilizing the stored compressed air in a timely manner.

Patent Document 1 discloses an adiabatic compressed air energy storage (ACAES) power generation device that recovers heat from compressed air before storing the compressed air and reheats the stored compressed air when supplying the compressed air to a turbine power generator. Since the ACAES power generation device recovers compression heat and uses the compression heat during power generation, the ACAES power generation device has high power generation efficiency as compared to a normal CAES power generation device. Hereinafter, an ACAES power generation device and a CAES power generation device are not distinguished from each other, and are simply referred to as a CAES power generation device.

### PRIOR ART DOCUMENT

### Patent Document

Patent Document 1: JP 2013-509529 A

### SUMMARY OF THE INVENTION

### Problems to be Solved by the Invention

For a CAES power generation device, from a viewpoint of installation space or the like, a compression/expansion combined machine, which is a compression machine driven by a motor that can also be used as an expansion machine that drives a power generator may be used. The compression/expansion combined machine includes a motor power generation combined machine (hereinafter, referred to as a motor power generator) having both functions as a motor and a power generator. Therefore, the compression/expansion combined machine has a compression function (a charging function in a CAES power generation device) and an expansion function (a power generation function in a CAES power generation device), which are usually switched according to a situation by an inverter controlling rotation speed of the compression/expansion combined machine.

For example, when switching from power generation to charging, power generation amount is reduced to zero, and then charging is performed. In particular, when reducing power generation amount, a phenomenon referred to as reverse power generation may occur. Reverse power generation is a phenomenon in which braking torque is generated when output frequency of an inverter is changed in order to reduce rotation speed of a power generator (rotation speed of an expansion machine) from a rated value to zero for example, and the braking torque contributes to an increase in power generation amount, making excessive power generation.

In power generation amount adjustment according to a command value based on input power and demand power, control of reverse power generation by an inverter is difficult, and unnecessary power is unintentionally generated. Therefore, in order to generate an appropriate amount of power, a method for reducing reverse power generation is required.

An object of the present invention is to suppress reverse power generation when rotation speed of a motor power generator is changed in a compressed air energy storage power generation device and a compressed air energy storage power generation method.

### Means for Solving the Problems

A first aspect of the present invention is to provide a compressed air energy storage power generation device including a compression/expansion combined machine having a function to produce compressed air utilizing electric power and a function to generate electric power utilizing the compressed air, a pressure storage unit that is fluidly connected to the compression/expansion combined machine and stores the compressed air, an inverter that adjusts rotation speed of the compression/expansion combined machine, a flow rate adjustment valve that adjusts amount of the compressed air supplied from the pressure storage unit to the compression/expansion combined machine, and a control device that reduces, when receiving a command value that reduces amount of power generated by the compression/expansion combined machine, amount of power generated by the compression/expansion combined machine by making the inverter to reduce rotation speed of the compression/expansion combined machine and decreasing an opening degree of the flow rate adjustment valve.

According to this configuration, amount of power generated by the compression/expansion combined machine can be adjusted by both the inverter and the flow rate adjustment valve. Especially when power generation amount is reduced, amount of compressed air supplied to the compression/expansion combined machine is reduced by decreasing the opening degree of the flow rate adjustment valve along with control of reducing rotation speed by the inverter. Even at the same rotation speed, the amount of power generated by the compression/expansion combined machine decreases if the amount of the compressed air supplied is small. Therefore, in the above-described configuration, power generation amount can be appropriately reduced by controlling the inverter and the flow rate adjustment valve together as compared with a case where only the inverter is controlled. With this arrangement, it is possible to substantially suppress an increase in power generation amount due to reverse power generation without changing conventional rotation speed control by the inverter.

The control device may adjust the opening degree of the flow rate adjustment valve according to a ratio of current rotation speed to rated rotation speed of the compression/expansion combined machine.

According to this configuration, compressed air can be efficiently supplied to the compression/expansion combined machine from a viewpoint of power generation efficiency. That is, efficient power generation with suppressed reverse power generation is possible by supplying a largest amount of compressed air at a rated rotation speed and by reducing compressed air supplied to the compression/expansion combined machine while current rotation speed decreases.

The control device may fully open the opening degree of the flow rate adjustment valve after the compression/expansion combined machine is stopped.

According to this configuration, power generation by the compression/expansion combined machine can be prepared. Once the compression/expansion combined machine is stopped, it takes a certain amount of time to restart the compression/expansion combined machine. It is preferable that the time is short, and it is preferable that smooth restart is possible. Thus, smooth restart is possible by fully opening the opening degree the flow rate adjustment valve in advance when the compression/expansion combined machine is stopped, in order to prepare supply of the compressed air in advance.

The command value may be a prediction value.

According to this configuration, control is performed on the basis of a prediction value, and therefore, efficient control with little time delay is possible. The prediction value is a prediction value of time variation of difference between input power and demand power, and may be calculated on the basis of past data in the same time zone, for example. Furthermore, for example, power amount (charge amount) may be predicted on the basis of a climate condition in a case where electric power input to the compression/expansion combined machine is renewable energy such as electric power generated by solar power or wind power. Furthermore, for example, in a case where required power generation amount is power amount required by a facility of a factory, or the like, power amount (charge amount) may be predicted according to operating hours of the facility of the factory, or the like at daytime or night time.

The control device may reduce, when receiving a command value that reduces power amount of 1 MW or more generated by the compression/expansion combined machine from 100% to 0% within 100 seconds, amount of power generated by the compression/expansion combined machine by making the inverter to reduce rotation speed of the compression/expansion combined machine and decreasing the opening degree of the flow rate adjustment valve.

According to this configuration, it is possible to suppress large reverse power generation that occurs when a command value that rapidly reduces a large amount of power generation is received. Large reverse power generation occurs when a large amount of power generation is reduced. In particular, it is possible to suppress large reverse power generation that may be a problem, which may occur if power generation amount of 1 MW or more is rapidly reduced from 100% to 0% within 100 seconds.

The control device may reduce, when a command value that switches the compression/expansion combined machine from power generation to charging is received, amount of power generated by the compression/expansion combined machine by making the inverter to reduce rotation speed of the compression/expansion combined machine and decreasing the opening degree of the flow rate adjustment valve.

According to this configuration, it is possible to suppress large reverse power generation that occurs when switching from power generation to charging. Large reverse power generation occurs when a large amount of power generation is reduced, and therefore may occur when switching from power generation to charging. Therefore, it is possible to suppress large reverse power generation that may occur when switching from power generation to charging.

A second aspect of the present invention is to provide a compressed air energy storage power generation method including preparing a compressed air energy storage power generation device including a compression/expansion combined machine having a function to produce compressed air utilizing electric power and a function to generate electric power utilizing the compressed air, a pressure storage unit that is fluidly connected to the compression/expansion combined machine and stores the compressed air, an inverter that adjusts rotation speed of the compression/expansion combined machine, and a flow rate adjustment valve that adjusts amount of the compressed air supplied from the pressure storage unit to the compression/expansion combined machine, and reducing, when receiving a command value that reduces amount of power generated by the compression/expansion combined machine, amount of power generated by the compression/expansion combined machine by making the inverter to reduce rotation speed of the compression/expansion combined machine and decreasing an opening degree of the flow rate adjustment valve.

### Effect of the Invention

According to the present invention, not only an inverter but also a flow rate adjustment valve is used for control of rotation speed of the compression/expansion combined machine in a compressed air energy storage power generation device and a compressed air energy storage power generation method, and therefore, reverse power generation can be suppressed.

### BRIEF DESCRIPTION OF THE DRAWINGS

FIG. 1 is a schematic configuration diagram of a compressed air energy storage power generation device according to an embodiment of the present invention; and

FIG. 2 is a graph illustrating a command value and actual charge amount/power generation amount.

### MODE FOR CARRYING OUT THE INVENTION

Hereinafter, an embodiment of the present invention will be described with reference to the accompanying drawings.

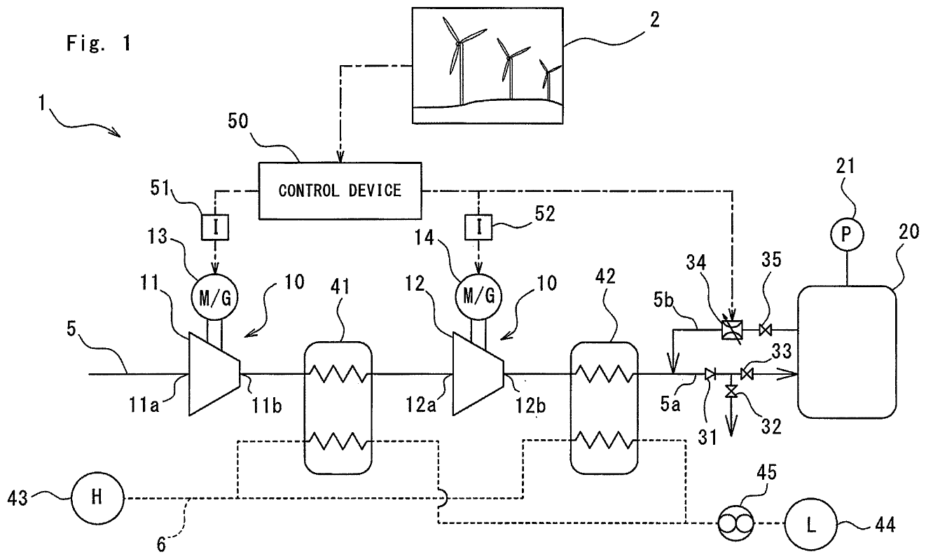

With reference to FIG. 1, a compressed air energy storage (CAES) power generation device 1 and a wind power plant 2 are electrically connected to an unillustrated grid power source. Because amount of power generated by the wind power plant 2 fluctuates according to weather, or the like, the CAES power generation device 1 is provided as an energy storage device for smoothing the fluctuating power generation amount and conducting power to or receiving power from the grid power source. Alternatively, the CAES power generation device 1 may be directly electrically connected to the wind power plant 2.

The CAES power generation device 1 includes a compression/expansion combined machine 10 and a pressure storage unit 20. These are fluidly connected by an air pipe 5. Air flows in the air pipe 5.

The compression/expansion combined machine 10 is of two-stage screw type. The compression/expansion combined machine 10 includes a low-pressure stage main body 11 and a high-pressure stage main body 12.

The low-pressure stage main body 11 includes a first port 11a that serves as an inlet/outlet of air on a low-pressure side and a second port 11b that serves as an inlet/outlet for air on a high-pressure side. The low-pressure stage main body 11 has an unillustrated male-female paired screw rotor. A motor power generator 13 is mechanically connected to the screw rotor. The motor power generator 13 has a function as a motor and a function as a power generator and can be used by switching between these. Specifically, air can be compressed by using the motor power generator 13 as a motor and rotating the screw rotor. Furthermore, electric power can be generated by expanding the compressed air to rotate the screw rotor and driving the motor power generator 13 as a power generator. Therefore, the compression/expansion combined machine 10 has a function to consume electric power from the wind power plant 2 to compress air and a function to generate electric power by utilizing compressed air from the pressure storage unit 20.

Similarly, also the high-pressure stage main body 12 includes a first port 12a that serves as an inlet/outlet of air on a low-pressure side and a second port 12b that serves as an inlet/outlet for air on a high-pressure side. The high-pressure stage main body 12 has an unillustrated male-female paired screw rotor. A motor power generator 14 is mechanically connected to the screw rotor. The motor power generator 14 has a compression function and a power generation function as similar to the low-pressure stage main body 11 described above.

The pressure storage unit 20 is fluidly connected to the second port 12b of the high-pressure stage main body 12 via the air pipe 5 to store compressed air. The CAES power generation device 1 stores in the pressure storage unit 20 compressed air compressed by the compression/expansion combined machine 10 and supplies the compressed air stored in the pressure storage unit 20 to the compression/expansion combined machine 10 to generate electric power. An aspect of the pressure storage unit 20 is not particularly limited as long as the pressure storage unit 20 can store compressed air, and may be, for example, a steel tank, underground space, or the like.

A pressure sensor 21 for measuring internal pressure is attached to the pressure storage unit 20. From a viewpoint of durability, or the like, the pressure storage unit 20 has an allowable value for amount of compressed air to be stored. Therefore, control by using the pressure sensor 21 as described later prevents the allowable value from being exceeded.

From the low-pressure side toward the high-pressure side, the air pipe 5 is provided with the low-pressure stage main body 11, a first heat exchanger 41 described later, the high-pressure stage main body 12, a second heat exchanger 42 described later, and the pressure storage unit 20. In particular, the air pipe 5, which fluidly connects the second port 12b of the high-pressure stage main body 12 and the pressure storage unit 20, branches in the middle, and branched air pipes 5a, 5b are provided with various valves 31 to 35 controlled by a control device 50 described later.

From the low-pressure side toward the high-pressure side, the branched air pipe 5a, which is one side of the above-described branched air pipes 5a, 5b, is provided with a check valve 31, an air release valve 32, and a shutoff valve 33 in the described order. The check valve 31 prevents backflow of air flowing toward the pressure storage unit 20. The air release valve 32 can release compressed air to the atmosphere when opened. Therefore, it is possible to prevent storage of compressed air in excess of the allowable value for internal pressure in the pressure storage unit 20 in the pressure storage unit 20. The shutoff valve 33 allows or shuts off flow of compressed air to the pressure storage unit 20.

From the low-pressure side toward the high-pressure side, the branched air pipe 5b, which is another side of the above-described branched air pipes 5a, 5b, is provided with a flow rate adjustment valve 34 and a shutoff valve 35 in the described order. The flow rate adjustment valve 34 adjusts a flow rate of compressed air that flows from the pressure storage unit 20 toward the compression/expansion combined machine 10. The shutoff valve 35 allows flow of compressed air from the pressure storage unit 20 to the compression/expansion combined machine 10.

Furthermore, the CAES power generation device 1 includes the first heat exchanger 41, the second heat exchanger 42, a high temperature heat storage unit 43, a low temperature heat storage unit 44, and a pump 45. These are fluidly connected by a heat medium pipe 6 (refer to the dashed lines). A heat medium flows in the heat medium pipe 6. A type of the heat medium is not particularly limited, and may be, for example, water or oil.

In the first heat exchanger 41, heat is exchanged between compressed air, which flows in the air pipe 5 extending between the low-pressure stage main body 11 and the high-pressure stage main body 12, and a heat medium that flows in the heat medium pipe 6. The first heat exchanger 41 may be, for example, a general-purpose plate-type heat exchanger.

In the second heat exchanger 42, heat is exchanged between compressed air, which flows in the air pipe 5 extending between the high-pressure stage main body 12 and the pressure storage unit 20, and a heat medium that flows in the heat medium pipe 6. The second heat exchanger 42 may be, for example, a general-purpose plate-type heat exchanger.

The high temperature heat storage unit 43 may be, for example, a steel tank. The high temperature heat storage unit 43 stores a high-temperature heat medium. Temperature of the heat medium stored in the high temperature heat storage unit 43 is maintained high enough to enable heat exchange, which is described later, between the first heat exchanger 41 and the second heat exchanger 42.

The low temperature heat storage unit 44 may be, for example, a steel tank. The low temperature heat storage unit 44 stores a low-temperature heat medium. Temperature of the heat medium stored in the low temperature heat storage unit 44 is maintained low enough to enable heat exchange, which is described later, between the first heat exchanger 41 and the second heat exchanger 42.

In the present embodiment, a route into which the first heat exchanger 41 is inserted and a route into which the second heat exchanger 42 is inserted are provided in the heat medium pipe 6 coupling the high temperature heat storage unit 43 and the low temperature heat storage unit 44. That is, the first heat exchanger 41 and the second heat exchanger 42 are not connected in series but are connected in parallel.

The pump 45 is controlled by the control device 50 described later, and causes a heat medium in the heat medium pipe 6 to flow. The pump 45 can switch between flowing a heat medium from the high temperature heat storage unit 43 to the low temperature heat storage unit 44 and flowing a heat medium from the low temperature heat storage unit 44 to the high temperature heat storage unit 43.

Furthermore, the CAES power generation device 1 includes the control device 50 and inverters 51, 52. These are electrically connected by wire or wirelessly (refer to the alternate long and short dash lines).

The inverter 51 is controlled by the control device 50. The inverter 51 adjusts rotation speed of the motor power generator 13 of the low-pressure stage main body 11.

The inverter 52 is controlled by the control device 50. The inverter 52 adjusts rotation speed of the motor power generator 14 of the high-pressure stage main body 12.

The control device 50 includes hardware such as a central processing unit (CPU), a random access memory (RAM), or a read only memory (ROM), and software implemented therein.

The control device 50 receives data related to electric power (input power) from the wind power plant 2 and electric power (demand power) required from a factory, or the like, which is not illustrated. Specifically, as a command value, the control device 50 receives a value obtained by subtracting demand power from input power. The control device 50 determines whether electric power is excess or insufficient according to the command value, and controls operation of the CAES power generation device 1. That is, on the basis of the determination by the control device 50, switching between charging and power generation by the compression/expansion combined machine 10 or control of rotation speed of the compression/expansion combined machine 10 is performed.

Charging operation and power generation operation of the CAES power generation device 1 having the above configuration will be described.

In the charging operation, the motor power generator 13 is driven, as a motor, by electric power from the wind power plant 2, and air is taken in from the first port 11a of the low-pressure stage main body 11 to be compressed. Compressed air compressed by the low-pressure stage main body 11 is heated by compression heat while being discharged from the second port 11b, and supplied to the first heat exchanger 41.

In the charging operation, a heat medium is flowed from the low temperature heat storage unit 44 toward the high temperature heat storage unit 43 by control of the pump 45. Therefore, high-temperature compressed air and low-temperature heat medium are supplied to the first heat exchanger 41, and heat is exchanged between these. Therefore, in the first heat exchanger 41, compressed air is cooled and a heat medium is heated. The compressed air cooled here is supplied to the first port 12a of the high-pressure stage main body 12, and the heated heat medium is supplied to and stored in the high temperature heat storage unit 43.

In the high-pressure stage main body 12, the motor power generator 14 is driven, as a motor, by electric power from the wind power plant 2, and compressed air supplied from the first port 12a is further compressed. Compressed air compressed by the high-pressure stage main body 12 is heated by compression heat while being discharged from the second port 12b, and supplied to the second heat exchanger 42.

In the charging operation, as described above, a heat medium is flowed from the low temperature heat storage unit toward the high temperature heat storage unit 43 by control of the pump 45. Therefore, high-temperature compressed air and low-temperature heat medium are supplied to the second heat exchanger 42, and heat is exchanged between these. Therefore, in the second heat exchanger 42, compressed air is cooled and a heat medium is heated. The compressed air cooled here is supplied to and stored in the pressure storage unit 20, and the heated heat medium is supplied to and stored in the high temperature heat storage unit 43. At this time, the shutoff valve 33 of the air pipe 5a is open, and the shutoff valve 35 of the air pipe 5b is closed.

Furthermore, in the charging operation, when the internal pressure in the pressure storage unit 20 measured by the pressure sensor 21 reaches an allowable value, the air release valve 32 is opened by the control device 50, and the compressed air is released to the atmosphere, instead of being stored in the pressure storage unit 20. With this arrangement, it is possible to prevent internal pressure in the pressure storage unit 20 from equaling or exceeding an allowable value.

In the power generation operation, the compressed air in the pressure storage unit 20 is supplied to the second heat exchanger 42. In the power generation operation, a heat medium is flowed from the high temperature heat storage unit 43 toward the low temperature heat storage unit 44 by control of the pump 45. Therefore, low-temperature compressed air and high-temperature heat medium are supplied to the second heat exchanger 42, and heat is exchanged between these. Therefore, in the second heat exchanger 42, compressed air is heated and a heat medium is cooled. The compressed air heated here is supplied to and stored in the second port 12b of the high-pressure stage main body 12, and the cooled heat medium is supplied to and stored in the low temperature heat storage unit 44. At this time, the shutoff valve 35 of the air pipe 5b is open, and the shutoff valve 33 of the air pipe 5a is closed. Furthermore, an opening degree of the flow rate adjustment valve 34 is adjusted by the control device 50 as described later, and a required amount of compressed air is supplied to the high-pressure stage main body 12.

The high-pressure stage main body 12 is driven by expanding compressed air supplied from the second port 12b, and drives the motor power generator 14 as a power generator to generate generates electric power. Compressed air expanded by the high-pressure stage main body 12 is exhausted from the first port 12a, and supplied to the first heat exchanger 41.

In the power generation operation, as described above, a heat medium is flowed from the high temperature heat storage unit 43 toward the low temperature heat storage unit 44 by control of the pump 45. Therefore, low-temperature compressed air and high-temperature heat medium are supplied to the first heat exchanger 41, and heat is exchanged between these. Therefore, in the first heat exchanger 41, compressed air is heated and a heat medium is cooled. The compressed air heated here is supplied to the second port 11b of the low-pressure stage main body 11, and the cooled heat medium is supplied to and stored in the low temperature heat storage unit 44.

The low-pressure stage main body 11 is driven by expanding compressed air supplied from the second port 11b, and drives the motor power generator 13 as a power generator to generate generates electric power. Compressed air expanded by the low-pressure stage main body 11 is exhausted from the first port 11a to the atmosphere.

Electric power generated by the high-pressure stage main body 12 and low-pressure stage main body 11 is supplied to a supply destination such as a factory, which is not illustrated.

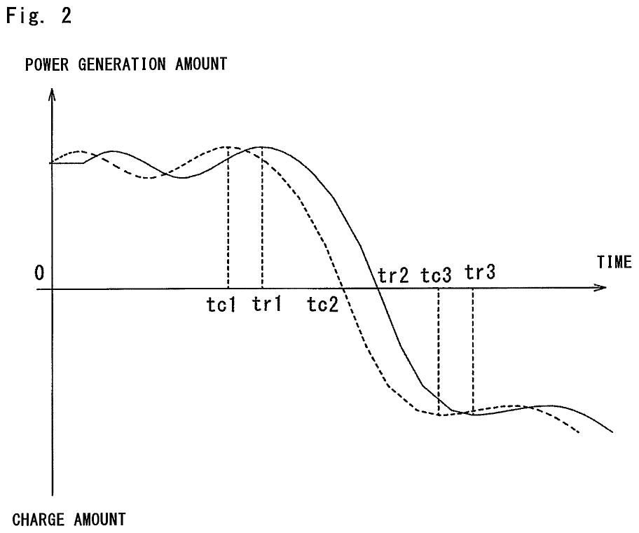

FIG. 2 is a graph illustrating a command value and actual charge amount/power generation amount. In the graph, the horizontal axis represents time, and the vertical axis represents charge amount/power generation amount. On the vertical axis of the graph, a positive value represents power generation amount and a negative value represents charge amount. The dashed-line curve represents a command value, and the solid-line curve represents an actual charge amount/power generation amount. The graph shows that actual charging/power generation is performed almost according to the command value, slightly behind the command value.

In the graph in FIG. 2, the command value largely decreases in a section between time tc1 and tc3, and a power generation command is switched to a charge command at time tc2. Correspondingly, the actual charge amount/power generation amount largely decreases in a section between time tr1 and tr3, and power generation operation is switched to charge operation at time tr2. However, the graph in FIG. 2 is merely a schematic example for explanation, and may differ from an actual one. For example, switching from power generation to charging may actually require standby time, and operation may be temporarily stopped.

The control device 50 reduces, when receiving a command value that reduces amount of power generated by the compression/expansion combined machine 10 as indicated at time tc1 to tc3 in the graph in FIG. 2, the amount of power generated by the compression/expansion combined machine 10 by making the inverters 51, 52 to reduce rotation speed of the compression/expansion combined machine 10 and decreasing the opening degree of the flow rate adjustment valve 34. That is, the control device 50 simultaneously performs control by the inverters 51, 52 of rotation speed of the motor power generators 13, 14 and control, by the flow rate adjustment valve 34, of a flow rate of compressed air that flows from the pressure storage unit 20 toward the compression/expansion combined machine 10. With this arrangement, amount of power generated by the compression/expansion combined machine 10 can be adjusted by the inverters 51, 52 and the flow rate adjustment valve 34. Especially when power generation amount is reduced, amount of compressed air supplied to the compression/expansion combined machine 10 is reduced by decreasing the opening degree of the flow rate adjustment valve 34 along with control of reducing rotation speed by the inverters 51, 52. Even at the same rotation speed, the compression/expansion combined machine 10 can suppress an excessive amount of power generation due to braking torque, and power generation amount is reduced by the amount if the amount of the compressed air supplied is small. Therefore, in the configuration in the present embodiment, power generation amount can be appropriately reduced by controlling the inverters 51, 52 and the flow rate adjustment valve 34, together as compared with a case where only the inverters 51, 52 are controlled. With this arrangement, it is possible to substantially suppress an increase in power generation amount due to reverse power generation without changing conventional rotation speed control by the inverters 51, 52.

Preferably, the above-described control is executed when a command value that rapidly reduces power amount of 1 MW or more generated by the compression/expansion combined machine 10 from 100% to 0% is received within 100 seconds. With this arrangement, it is possible to suppress large reverse power generation that occurs when a command value that rapidly reduces power generation amount is received. Large reverse power generation occurs when a large amount of power generation is reduced. In particular, it is possible to suppress large reverse power generation that may be a problem, which may occur if power generation amount of 1 MW or more is rapidly reduced from 100% to 0% within 100 seconds.

Preferably, the above-described control is executed when a command value that switches the compression/expansion combined machine 10 from power generation to charging is received as indicated at time tc2 in the graph in FIG. 2. With this arrangement, it is possible to suppress large reverse power generation that occurs when switching from power generation to charging. Large reverse power generation occurs when a large amount of power generation is reduced, and therefore may occur when switching from power generation to charging. Therefore, it is possible to suppress large reverse power generation that may occur when switching from power generation to charging.

Preferably, the control device 50 adjusts the opening degree of the flow rate adjustment valve 34 according to a ratio of current rotation speed to rated rotation speed of the compression/expansion combined machine 10. For example, assuming that rated rotation speed Nc and current rotation speed Nr are provided, the opening degree of the flow rate adjustment valve 34 is set according to dimensionless quantity Nr/Nc, and the opening degree of the flow rate adjustment valve 34 is maximized when the current rotation speed Nr is equal to the rated rotation speed Nc. With this arrangement, compressed air can be efficiently supplied to the compression/expansion combined machine 10 from a viewpoint of power generation efficiency. That is, efficient power generation with reduced reverse power generation is achieved, since the opening degree of the flow rate adjustment valve 34 is maximized when the current rotation speed Nr is equal to the rated rotation speed Nc, and a largest amount of compressed air is supplied to the compression/expansion combined machine 10, and since an amount of compressed air supplied to the compression/expansion combined machine 10 is reduced while current rotation speed Nr decreases.

Preferably, the control device 50 fully opens the opening degree of the flow rate adjustment valve 34 after the compression/expansion combined machine 10 is stopped. With this arrangement, power generation by the compression/expansion combined machine 10 can be prepared. Once the compression/expansion combined machine 10 is stopped, it takes a certain amount of time to restart the compression/expansion combined machine 10. It is preferable that the time is short, and it is preferable that smooth restart is possible. Thus, smooth restart is possible by fully opening, when the compression/expansion combined machine 10 is stopped, the opening degree of the flow rate adjustment valve 34 in advance to prepare supply of the compressed air in advance.

Preferably, a command value is a prediction value. With this arrangement, control is performed on the basis of a prediction value, and therefore, efficient control with little time delay is possible. The prediction value may be calculated on the basis of past data in the same time zone, for example. Furthermore, for example, power amount (charge amount) of wind power generation may be predicted on the basis of a climate condition in a case where electric power input to the compression/expansion combined machine 10 is renewable energy such as wind power, as in the present embodiment. Furthermore, for example, in a case where required power generation amount is power amount required by a facility of a factory, or the like, power amount (charge amount) may be predicted according to operating hours of the facility of the factory, or the like at daytime or night time.

Although a specific embodiment of the present invention has been described above, the present invention is not limited to the above embodiment, and various modifications can be made within the scope of the present invention. For example, the compression/expansion combined machine 10 is not limited to of two-stage type, but may be of single-stage type or three-stage type or more. Furthermore, the compression/expansion combined machine 10 is not limited to of screw-type, but may be of rotary-type such as scroll-type. Furthermore, electric power supplied to the compression/expansion combined machine 10 is not limited to wind power generation, but may be any electric power generated utilizing irregularly fluctuating energy constantly or repeatedly replenished by natural forces such as solar power, solar heat, wave power, tidal power, running water, or sea tide. Furthermore, in addition to renewable energy, electric power supplied to the compression/expansion combined machine 10 may be any power, such as power generated by a factory with a power generation facility that irregularly operates and in which power generation amount fluctuates.

In the above-described embodiment, although an inverter and a motor power generator are provided for each of the low-pressure stage main body 11 and the high-pressure stage main body 12, the low-pressure stage main body 11 and the high-pressure stage main body 12 may share the inverter and the motor power generator. Specifically, one inverter may be electrically connected to one motor power generator, and one motor power generator may be mechanically connected to each of the low-pressure stage main body 11 and the high-pressure stage main body 12 via a gear.

### DESCRIPTION OF SYMBOLS

1 CAES power generation device (compressed air energy
2 storage power generation device)
2 Wind power plant
5, 5a, 5b Air pipes
6 Heat medium pipe
10 Compression/expansion combined machine
11 Low-pressure stage main body
11a l First port
11b Second port
12 High-pressure stage main body
12a First port
12b Second port
13, 14 Motor power generators
20 Pressure storage unit
21 Pressure sensor
31 Check valve
32 Air release valve
33 Shutoff valve
34 Flow rate adjustment valve
35 Shutoff valve
41 First heat exchanger
42 Second heat exchanger
43 High temperature heat storage unit
44 Low temperature heat storage unit
45 Pump
50 Control device
51, 52 Inverters

1. A compressed air energy storage power generation device comprising:
a compression/expansion combined machine having a function to produce compressed air utilizing electric power and a function to generate electric power utilizing the compressed air;
a pressure storage unit that is fluidly connected to the compression/expansion combined machine and stores the compressed air;
an inverter that adjusts rotation speed of the compression/expansion combined machine;
a flow rate adjustment valve that adjusts amount of the compressed air supplied from the pressure storage unit to the compression/expansion combined machine; and
a control device that reduces, when receiving a command value that reduces amount of power generated by the compression/expansion combined machine, amount of power generated by the compression/expansion combined machine by making the inverter to reduce rotation speed of the compression/expansion combined machine and decreasing an opening degree of the flow rate adjustment valve.

2. The compressed air energy storage power generation device according to claim 1,
wherein the control device adjusts the opening degree of the flow rate adjustment valve according to a ratio of current rotation speed to rated rotation speed of the compression/expansion combined machine.

3. The compressed air energy storage power generation device according to claim 1,
wherein the control device fully opens the opening degree of the flow rate adjustment valve after the compression/expansion combined machine is stopped.

4. The compressed air energy storage power generation device according to claim 1,
wherein the command value is a prediction value.

5. The compressed air energy storage power generation device according to claim 1,
wherein the control device reduces, when receiving a command value that reduces power amount of 1 MW or more generated by the compression/expansion combined machine from 100% to 0% within 100 seconds, amount of power generated by the compression/expansion combined machine by making the inverter to reduce rotation speed of the compression/expansion combined machine and decreasing the opening degree of the flow rate adjustment valve.

6. The compressed air energy storage power generation device according to claim 1,
the control device reduces, when receiving a command value that switches the compression/expansion combined machine from power generation to charging, amount of power generated by the compression/expansion combined machine by making the inverter to reduce rotation speed of the compression/expansion combined machine and decreasing the opening degree of the flow rate adjustment valve.

7. A compressed air energy storage power generation method comprising:
preparing a compressed air energy storage power generation device including a compression/expansion combined machine having a function to produce compressed air utilizing electric power and a function to generate electric power utilizing the compressed air, a pressure storage unit that is fluidly connected to the compression/expansion combined machine and stores the compressed air, an inverter that adjusts rotation speed of the compression/expansion combined machine, and a flow rate adjustment valve that adjusts amount of the compressed air supplied from the pressure storage unit to the compression/expansion combined machine; and
reducing, when receiving a command value that reduces amount of power generated by the compression/expansion combined machine, amount of power generated by the compression/expansion combined machine by making the inverter to reduce rotation speed of the compression/expansion combined machine and decreasing an opening degree of the flow rate adjustment valve.

8. The compressed air energy storage power generation device according to claim 2,
wherein the control device fully opens the opening degree of the flow rate adjustment valve after the compression/expansion combined machine is stopped.

9. The compressed air energy storage power generation device according to claim 2,
wherein the command value is a prediction value.

10. The compressed air energy storage power generation device according to claim 2,
wherein the control device reduces, when receiving a command value that reduces power amount of 1 MW or more generated by the compression/expansion combined machine from 100% to 0% within 100 seconds, amount of power generated by the compression/expansion combined machine by making the inverter to reduce rotation speed of the compression/expansion combined machine and decreasing the opening degree of the flow rate adjustment valve.

11. The compressed air energy storage power generation device according to claim 2,
the control device reduces, when receiving a command value that switches the compression/expansion combined machine from power generation to charging, amount of power generated by the compression/expansion combined machine by making the inverter to reduce rotation speed of the compression/expansion combined machine and decreasing the opening degree of the flow rate adjustment valve.
